(19) United States
(12) Patent Application Publication
(10) Pub. No.: US 2025/0012641 A1
(43) Pub. Date: Jan. 9, 2025

(54) METHOD FOR DETERMINING A PRODUCT TEMPERATURE

(71) Applicant: Testo SE & Co. KGaA, Titisee-Neustadt (DE)

(72) Inventors: David Schmitt, Freiburg (DE); Jan-Friso EVERS-SENNE, Titisee-Neustadt (DE)

(73) Assignee: Testo SE & Co. KGaA, Titisee-Neustadt (DE)

(21) Appl. No.: 18/760,399

(22) Filed: Jul. 1, 2024

(30) Foreign Application Priority Data
Jul. 6, 2023 (DE) 102023117855.5

(51) Int. Cl. G01K 11/00

(52) U.S. Cl. CPC G01K 11/00

(57) ABSTRACT

A method for determining a temperature of a product within a defined environment, in which the ambient temperature is measured at at least one position, and a product temperature is ascertained from the ambient temperature taking into consideration a product coefficient c. The product coefficient c is previously ascertained in a two-step method, wherein in a first step an approximate value for the product coefficient c is ascertained by an artificial intelligence, AI, and in a second step the product coefficient c is determined starting from the approximate value and at least one control measurement.

### CROSS-REFERENCE TO RELATED APPLICATIONS

This application claims priority from German Patent Application No. DE 10 2023 117 855.5, filed Jul. 6, 2023, which is incorporated herein by reference as if fully set forth.

### TECHNICAL FIELD

The invention describes a method for determining a temperature of a product within a defined environment.

### BACKGROUND

The temperature of foods plays a central role in upholding quality standards and in maintaining food safety. This temperature therefore has to be recorded. Products are generally located in refrigerators, freezers, or heat retention devices, which ensure that the temperature of the product is in the desired range. Product temperatures are therefore important monitoring variables above all in trade, in transportation, and in gastronomy.

Products and goods are stored in this case in cold storage rooms or refrigerators. However, it is to be noted in this case that a homogeneous temperature is not present therein, but rather always a temperature distribution. This is usually related to construction or design.

Independently thereof, however, various products also have further physical properties that influence a product temperature. For example, a deep-frozen product maintains its temperature for a long time even at room temperature. However, this applies in the same way in reverse, which means that a warm product still remains warm for some time in cold environments. A temperature measurement in a room can therefore only supply a statement about the environment, which does not necessarily apply to the products stored therein.

Currently, the state of the products is determined on the basis of the air temperature, which is recorded by a data logger at a specific point in the device. Alarms are triggered on the basis of this air temperature.

In addition to measuring the air temperature, manual measurements of the products, for example by means of piercing thermometers, are used as spot checks. These products are to be discarded after the measurement, however.

### SUMMARY

The object of the invention is to provide a method for determining a product temperature which is essentially independent of the environment.

This object is achieved by a method having one or more of the features noted herein. The method according to the invention is characterized in that the ambient temperature is measured at at least one position, and in that a product temperature is ascertained from the ambient temperature in consideration of a product coefficient c, wherein the product coefficient c was previously ascertained in a two-step method, wherein in a first step an approximate value for the product coefficient c is ascertained by an artificial intelligence, AI, wherein in a second step the product coefficient c is determined starting from the approximate value and at least one control measurement.

The advantage is now that an ambient temperature, which is measured, for example, in a cold storage room or refrigerator, is converted with the aid of the product coefficient into a product temperature. Many properties of the product and the environment are thus taken into consideration, so that the product temperature is mapped better.

In closed systems, the entropy can only increase or remain the same according to the second law of thermodynamics. Systems always tend toward the state of maximum entropy. If a body having a specific temperature T1 is thus brought into a closed system having a temperature T2, a temperature equalization will take place, so that after a certain time T1=T2. The system has thus reached the state of maximum entropy. This equalization state can be approximated as an e function. The equalization behavior is physically influenced by the following factors, among other things:
heat capacity and coefficient of heat transfer of the product,
heat conduction resistance of the package,
temperature difference between product and environment,
convection in environment, and
heat capacity of the environment.

The further advantage of the invention is now that the product coefficient maps these physical properties without complex and intensive calculations.

Moreover, the product coefficient is ascertained by an artificial intelligence. In this way, a very large number of input parameters can be taken into consideration, wherein the input parameters are not these physical variables, however, but rather specifications and empirical data on the product.

Due to the use of the AI, the product coefficient can thus be determined in a simple manner without directly knowing and taking into consideration the physical relationships. In this way, it is then sufficient, for example, to specify as an input parameter that, for example, frozen peas are used, and it is not necessary, for example, to know the heat capacity of frozen peas.

In this way, products can also be used without a large number of pre-determinations, measurements, and/or tests having to be carried out for each individual product.

The artificial intelligence can comprise, for example, an artificial neural network.

The calculation of the temperature is moreover very simple due to the simple product coefficient and requires little computing power. It can therefore also take place in a mobile measuring device or, for example, on a smart phone or a similar device.

In addition, spot-check measurements can be reduced or dispensed with entirely, so that less food has to be discarded.

In one embodiment of the invention, a repositioning coefficient d is additionally taken into consideration in the ascertainment of the product temperature. This repositioning coefficient takes into consideration the location or position of the product within the environment. It can thus be taken into consideration that the temperature within the environment is not homogeneous. The advantage is that by way of a temperature measurement at one position, the temperature distribution within the environment is taken into consideration and a correct product temperature is determinable. For this purpose, only a distance to the location of the temperature measurement is generally required.

In one embodiment, the repositioning coefficient d is ascertained by the or an AI.

In one embodiment, the AI receives as input parameters at least specifications on: product, application, device, package, device volume, usage behavior, median, standard deviation, and measuring rate.

Product describes the type of the product (such as ground meat, fish sticks, peas, etc.).

Use or application is, for example, cooling, freezing, keeping warm (hot holding) etc.

Device describes the type of the device in which the product is stored (such as cold storage, chest freezer, etc.).

Package describes the type of the package (such as cardboard, plastic basket, plastic bag, Styrofoam, etc.).

Device volume describes the volume of the device or the usable space, for example in cubic meters.

Usage behavior describes the type of the usage, for example continuous usage or noncontinuous usage.

Median describes the median of the or all recorded temperatures for the combination of input parameters.

Standard deviation describes the standard deviation of the recorded temperatures.

Measuring rate describes the interval or at which frequency new measured values are recorded.

The AI can receive further input parameters if this is necessary due to the application, because of which the above-mentioned list is not exhaustive. A product coefficient and possibly a repositioning coefficient in addition are produced as the output of the AI. Under certain circumstances, different AIs can be used for the two coefficients.

The AI, particularly an artificial neural network, has to be trained beforehand by training data.

In one embodiment, for training the AI on specific input parameters, an associated product coefficient and repositioning coefficient are ascertained by measurements and/or experiments and supplied with the underlying input parameters of the AI as training data.

The input parameters which are used later are expediently used as training data. The training data can be based here on real measured values or other real or empirical values. A temperature profile within the device could thus be determined, for example, for a chest freezer by multiple temperature measurements. Time profiles of the product temperature and other parameters could also be ascertained for various products. These empirical values result in one or both coefficients, which are then transferred as the training value together with the respective input parameters to the AI.

However, the number of the values to be ascertained can be greatly reduced by the use of the AI. It is therefore possible, for example, to determine the coefficients even for combinations of input values for which no direct measured values are present.

In one embodiment, the product temperature is calculated according to the formula:

$${T}_{n} = \frac{( {T}_{m} + ( {T}_{n - 1} - d ) * c )}{( c + 1 ) + d}$$

wherein Tₘ is the measured ambient temperature, Tₙ₋₁ is the product temperature ascertained in the prior measuring cycle, c is the product coefficient, and d is the repositioning coefficient. Tₙ is then the product temperature ascertained in this measuring cycle.

In one embodiment, two measurement series are recorded in the second step during the control measurement, wherein the first measurement series comprises an ambient temperature and the second measurement series comprises the product temperature and wherein the product coefficient and possibly the repositioning coefficient are adapted so that the ascertained temperature of the second measurement series is approached. In this way, it is possible for the training of the AI to determine the product coefficient and possibly the repositioning coefficient more accurately.

### BRIEF DESCRIPTION OF THE DRAWINGS

The invention will be explained in more detail hereinafter on the basis of exemplary embodiments with reference to the appended drawings.

In the figures:

FIG. 1 shows a schematic sectional view through a chest freezer,

FIG. 2 shows various temperature profiles at various positions within the chest freezer of FIG. 1,

FIG. 3 shows various temperature profiles for an exemplary application of ground meat in a refrigerator,

FIG. 4 shows a schematic block diagram of a measuring arrangement,

FIG. 5 shows a flow chart of a method according to the invention for determining a product temperature, and

FIG. 6 shows a flow chart of a method for determining the product coefficient and the repositioning coefficient.

### DETAILED DESCRIPTION

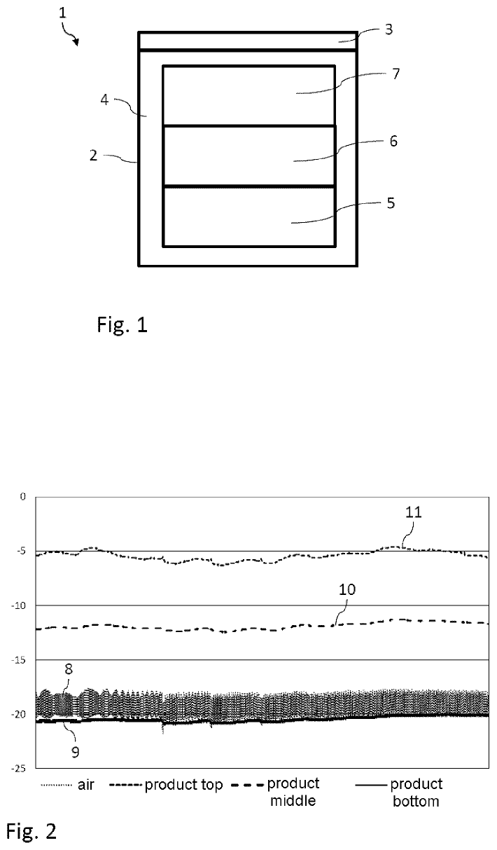

FIG. 1 schematically shows a section through a chest freezer 1. The chest freezer 1 has a freezer body 2, which is open on top in the example and is closed by a movable lid 3. A freezer compartment 4, into which frozen goods can be inserted, is in the freezer body 2.

Because of the design, a temperature profile exists in the freezer compartment 4, which is indicated in approximate form here by three temperature zones. The coldest temperature is present in the bottom temperature zone 5. It is warmer in the middle temperature zone 6 and it is warmest in the top temperature zone 7.

FIG. 2 shows by way of example the temporal temperature profile of the air temperature 8 within a chest freezer 1 according to FIG. 1. It can be seen here that the air temperature 8 varies by approximately 4° C. over time.

The bottom product temperature 9 shows the temporal temperature profile of a product within the bottom temperature zone 5 of the chest freezer 1. This bottom product temperature 9 is significantly below the air temperature 8 and is subject to substantially smaller variations.

The middle product temperature 10 shows the temporal temperature profile of a product within the middle temperature zone 6 of the chest freezer 1. The middle product temperature 10 is essentially 7.5° C. above the lower product temperature 9.

The upper product temperature 11 shows the temporal temperature profile of a product within the upper temperature zone 7 of the chest freezer 1. The upper product temperature 11 is essentially 15° C. above the lower product temperature 9.

It thus becomes clear that a measurement of the air temperature at one point within the freezer compartment 4 is not sufficient to determine a product temperature.

This temperature difference between the temperature zones can be taken into consideration according to the invention by the repositioning coefficient.

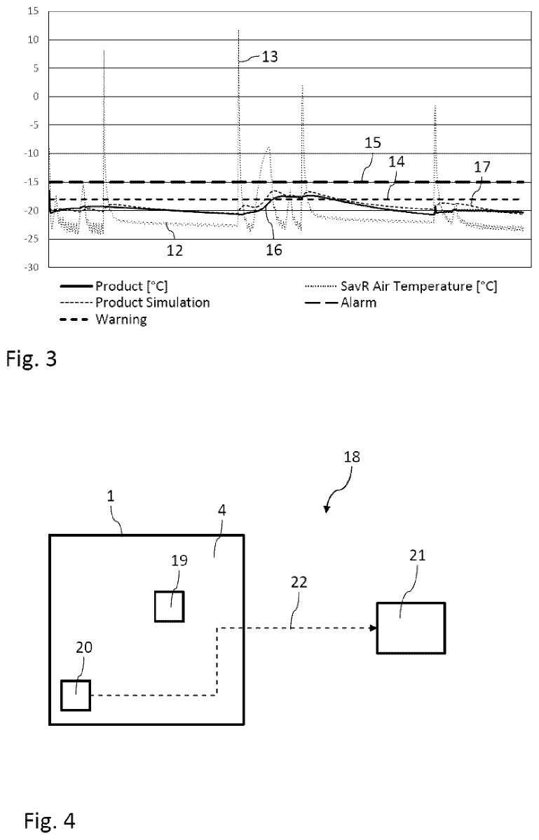

FIG. 3 shows the temporal temperature profile on a further example, here a ground meat sample within a chest freezer 1, for example according to FIG. 1.

The air temperature 12 shows multiple peaks 13 here, which arise, for example, due to opening of the lid 2. A warning limit temperature 14 and sometimes also the alarm limit temperature 15 are exceeded in this case, due to which an alarm would be triggered.

However, the product temperature 16 only follows the peaks 13 with a delay and not so strongly that the alarm limit temperature 15 is exceeded. In the middle region, in which multiple peaks 13 are close to one another, however, the warning limit temperature 14 is exceeded.

The air temperature 12 and the product temperature 16 are measured values. In contrast, the simulated product temperature 17 is calculated by the method according to the invention. It can be seen clearly here that the simulated product temperature 17 follows the peaks 13 more clearly than the actual product temperature, but always remains below the alarm limit temperature 15, as does the product temperature 16. Overall, the deviation between product temperature 16 and simulated product temperature 17 is very minor. The method according to the invention is therefore very well suitable for very accurately determining a product temperature starting from the measured air temperature.

FIG. 4 shows a block diagram of a measurement arrangement 18 having a chest freezer 1 having a freezer compartment 4. A product 19 and a data logger 20 are arranged in the freezer compartment 4. The data logger 20 is designed for measuring an air temperature within the freezer compartment 4. The measurement is repeated at a predefined measuring rate in uniform intervals. For example, one measurement can take place per minute. The product 19 is at a distance to the data logger 20. The data logger 20 can be designed to store the individual measurements over a specific period of time. At the end of the period of time, the data logger 20 can be connected to an evaluation unit 21 in order to transmit the measured values. Alternatively or additionally, the data logger 20 can also be permanently or temporarily connected to an evaluation unit 21, for example, via a wireless radio connection, in order to transmit measured values continuously or at shorter intervals to the evaluation unit 21. The evaluation unit 21 can be mobile, such as a smart phone, or stationary, for example.

In the example, an evaluation unit 21 is arranged outside the chest freezer 1, which is connected to the data logger 20 via a radio connection 22 in order to transmit measurement data.

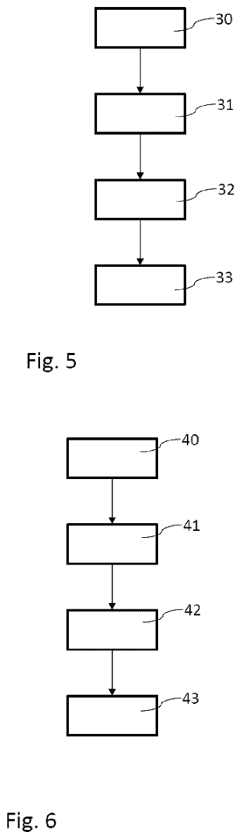

The method according to the invention can be applied in practice in the following way, for example. FIG. 5 schematically shows a flow chart of the method. A temperature measuring device, such as a data logger 20, is arranged in a first step 30 in a cold storage room or a chest freezer 1. In step 31, the data logger 20 measures the ambient temperature within the freezer compartment 4, such as the air temperature, at a specific measuring rate or interval. The measured values are transmitted in a further step 32 wirelessly via radio to the evaluation unit 21.

In a next step 33, a product temperature is determined according to the method according to the invention in the evaluation unit 21 from the measured air temperature.

For each measured value of the data logger, the product temperature is determined for each product in step 33, for example, using the above-mentioned formula:

$${T}_{n} = \frac{{T}_{m} + ( {T}_{n - 1} - d ) * c}{c + 1} + d$$

The product coefficient c plays a decisive role here. It has to be known to calculate the product temperature. According to the invention, it was previously determined for each product stored in the chest freezer by a correspondingly trained AI. The above-mentioned product and device parameters are used as input parameters.

This can also take place once beforehand, wherein the product coefficients c(product) of each product can be stored, for example, in a table within the evaluation unit 21.

Because each measured value is dependent on the temperature value ascertained immediately beforehand, a temporal profile results which moreover avoids extreme peaks. The profile of the individual measured values is stored in a step 34. The repositioning coefficient d has a directly additive effect here. In the example of FIG. 1, the repositioning coefficient d for products in the bottom temperature zone 5 would then be d(bottom)=0, in the middle temperature zone 6 d(middle)=7.5° C., and in the top temperature zone 7 d(top)=15° C.

Depending on the application, an environment can also be divided into multiple temperature zones. The repositioning coefficient d can also be determined on the basis of a formula from a distance so that discrete temperature zones are not necessary. This can be advisable, for example, in large environments, such as refrigerated warehouses or storage rooms.

In the example of FIG. 4, the repositioning coefficient d can be determined from the distance between the data logger 20 and the product 19.

The product coefficient c is determined according to the invention in a two-step method.

FIG. 5 shows a flow chart of a method for determining the product coefficient.

In a first step 40, an approximate value for the product coefficient c is ascertained by an artificial intelligence, AI.

In a second step 41, two measurement series are recorded during a control measurement, wherein the first measurement series comprises an ambient temperature and the second measurement series comprises the product temperature.

In a further step 42, a product temperature is ascertained from the ambient temperature using the approximate value from the first step.

In a further step 43, the product coefficient is adapted so that the ascertained product temperature of the second measurement series, thus the measured product temperature, is approximated.

In the control measurement, a position of the product in relation to the ambient temperature measurement can also be taken into consideration, so that a repositioning coefficient can also be ascertained.

For the first step, an AI, such as an artificial neural network, which has previously been trained using corresponding data is necessary. The input parameters are described above. The coefficients matching thereto, thus product coefficient and repositioning coefficient, have to be ascertained by experiments for the training. The advantage in the use of an AI is that an experiment does not have to be carried out for every combination of input parameters. This is because the AI can compensate for these missing experiments.

### LIST OF REFERENCE SIGNS

1 chest freezer
2 freezer body
3 lid
4 freezer compartment
5 bottom temperature zone
6 middle temperature zone
7 top temperature zone
8 air temperature
9 bottom product temperature
10 middle product temperature
11 top product temperature
12 air temperature
13 peak
14 warning limit temperature
15 alarm limit temperature
16 product temperature
17 simulated product temperature
18 measurement arrangement
19 product
20 data logger
21 evaluation unit
22 radio connection
30-33 method steps
40-43 method steps

1. A method for determining a product temperature within a defined environment, the method comprising:
measuring an ambient temperature at at least one position, and
ascertaining the product temperature from the ambient temperature taking into consideration a product coefficient c,
wherein the product coefficient c is previously ascertained in a two-step method,
including:
in a first step, ascertaining an approximate value for the product coefficient c by an artificial intelligence, AI, and
in a second step, determining the product coefficient c starting from the approximate value and at least one control measurement.

2. The method as claimed in claim 1, further comprising taking a repositioning coefficient d into consideration during the ascertaining of the product temperature.

3. The method as claimed in claim 2, wherein the repositioning coefficient d is ascertained by AI.

4. The method as claimed in claim 1, further comprising the AI receiving as input parameters at least specifications on: product, application, device, package, device volume, usage behavior, median, standard deviation, and measuring rate; and produces the product coefficient as an output.

5. The method as claimed in claim 1, wherein, for training of the AI on specific input parameters, the method further includes ascertaining an associated product coefficient and repositioning coefficient by measurements and feeding the associated product coefficient and repositioning coefficient along with underlying input parameters to the AI as training data.

6. The method as claimed in claim 1, further comprising calculating the product temperature according to the formula:
$${T}_{n} = \frac{{T}_{m} + ( {T}_{n - 1} - d ) * c}{c + 1} + d .$$

7. The method as claimed in claim 1, wherein, in the second step, first and second measurement series are recorded in a control measurement, wherein the first measurement series comprises the ambient temperature and the second measurement series comprises the product temperature and wherein in a further step the product coefficient is adapted so that the ascertained temperature of the second measurement series is approximated.

8. The method as claimed in claim 7, further comprising taking a repositioning coefficient d into consideration during the ascertaining of the product temperature, and in the further step, the repositioning coefficient is adapted along with the product coefficient so that the ascertained temperature of the second measurement series is approximated.
